(19) United States
(12) Patent Application Publication
(10) Pub. No.: US 2003/0108685 A1
(43) Pub. Date: Jun. 12, 2003

(54) Method of manufacturing liquid crystal display apparatus and liquid crystal display apparatus

(76) Inventors: Hayami Tabira, Yokohama (JP); Takashi Inoue, Yokohama (JP)

Correspondence Address: Mattingly, Stanger & Malur, P.C., Suite 370, 1800 Diagonal Road, Alexandria, VA, 22314, US

(21) Appl. No.: 10/235,820

(22) Filed: Sep. 6, 2002

(30) Foreign Application Priority Data
Nov. 22, 2001 (JP) 2001-357226

(51) Int. Cl. C09K 19/00

(52) U.S. Cl. 428/1.2

(57) ABSTRACT

A method of manufacturing a liquid crystal display apparatus, comprising the step of rubbing with a rubbing cloth a substrate provided thereon with an alignment layer. The rubbing cloth comprises a pile portion with raised fibers, and the fibers comprising a cellulose acetate. The fibers comprising a cellulose acetate may be filament yarns provided with crimps. The cellulose acetate may have an acetylation degree of 45% or more. This method has a rubbing step making use of a rubbing cloth having properties of high wear resistance, low frictional electrification and great alignment force together, and enables manufacture of a liquid crystal display apparatus having high reliability.

This application is based on Japanese Patent Application No. 2001-357226 filed in Japan, the contents of which are incorporated hereinto by reference.

### BACKGROUND OF THE INVENTION

1. Field of the Invention

This invention relates to a method of manufacturing a liquid crystal display apparatus; the method including a step of controlling the alignment of liquid crystal molecules by rubbing with a rubbing cloth an alignment layer formed on a substrate, in the manufacturing process of liquid crystal display panels.

2. Description of the Related Art

Transmission-type liquid crystal display panels are composed of a TFT substrate, a color filter substrate and liquid crystal which is encapsulated in the small gap between these two substrates. The TFT substrates has pixel driving devices made of thin-film transistor (TFT) array. The color filter substrate (hereinafter simply “CF substrate”) has an area patterned color filter layer. On the TFT substrate, patterned ITO (indium-tin oxide) film is fabricated as pixel electrodes which are entirely covered with an alignment layer.

While CF substrate has a common ITO electrode which is again fully coated with the alignment layer. These two substrates are assembled in face-to-face fashion where the two alignment layers directly sandwich the encapsulated liquid crystal.

The alignment layers of the TFT substrate and CF substrate have been subjected to an aligning treatment process in order to bring liquid crystal molecules into alignment. For the aligning treatment process, a rubbing method where the alignment layer surface is rubbed with a rubbing cloth is mainly used. Usually, the rubbing method employs aluminum or stainless-steel roller whose curved surface is covered with the rubbing cloth. The roller is brought into contact with the alignment layer surface while rotated; and the surface of the alignment layer is rubbed with the rubbing cloth. This process is called rubbing process. By using the alignment layer subjected to such rubbing process for a liquid crystal display device, liquid crystal molecules can be aligned in the direction in which the alignment layer has been rubbed with the rubbing cloth. Accordingly, uniform display characteristics of the liquid crystal display panel have been achieved.

As the rubbing cloth, velvet is commonly used which comprises a ground sheet and a pile of raised fibers. Pile density of velvet for rubbing cloths has been adjusted by changing thickness of the pile fibers or thickness of the fibers used for the ground sheet. Pile length of velvet for rubbing cloth has also been adjusted by changing the cut position when the tip end of the pile is cut. As for fiber materials used for the pile, that of long fibers (filaments) such as rayon and nylon and that of short fibers such as cotton are known in the art.

Japanese Patent Application Laid-open No. 7-270798 discloses a use of aramid fibers for a rubbing cloth. Japanese Patent Application Laid-open No. 6-194662 also discloses a method for the aligning treatment process of an alignment layer, which uses fibrous protein in a rubbing cloth. Japanese Patent Application Laid-open No. 6-194661 still also discloses a method for the aligning treatment process of an alignment layer, making use of a rubbing cloth made of casein.

### SUMMARY OF THE INVENTION

In the conventional technology, there is a problem that a rubbing cloth whose pile is made of rayon has insufficient wear resistance. Specifically, in the rubbing cloth made of rayon, the pile tends to be worn to produce pile debris in the course of rubbing. When the debris sticks to the alignment layer surface, a distance (liquid crystal cell gap) between a two glass substrate surfaces facing to each other in a liquid crystal display device becomes non-uniform, providing a faulty display.

Such debris also tends to be entangled in the rubbing cloth. If the alignment layer is rubbed with the rubbing cloth having the debris, the alignment layer surface is scratched. The scratches thus formed may cause a blank area in the liquid crystal display device. In addition, the worn rubbing cloth lacks in uniformity, so that the rubbing process tends to become non-uniform if you use in the worn cloth, giving another faulty display. Accordingly, frequent replacement of the rubbing cloth is required in the case of rayon rubbing cloth. As described above, we have found a problem of insufficient wear resistance in the rubbing cloth made of rayon.

As for the rubbing cloth whose pile is made of cotton, wear resistance of the pile is improved a little, compared with that of rayon.

This is because, although both the cotton and the rayon mainly comprise cellulose as basic skeleton, the cotton has a larger molecular weight than the rayon. Therefore, the cotton has a higher material strength. However, since the cotton is naturally occurring short fiber, its pile yarn is spun yarn obtained by spinning the short fibers. Thus, the thickness of individual pile yarn of cotton is larger than those of filaments which comprise synthetic fiber or semisynthetic fiber such as nylon and rayon.

Since the cotton piles are made of short fibers, such short fibers of cotton tend to come off and drop on the substrate during rubbing process. Moreover, since the cotton is natural fiber, the quality of fiber itself may differ more greatly than that of the synthetic fiber or semisynthetic fiber, depending on the growing places and climates. Thus, the rubbing cloth made of cotton has a lower pile uniformity than that of rayon and nylon. Hence, when the rubbing cloth made of cotton is used, streaky brightness nonuniformity called “rubbing streaks” is more likely to occur in the liquid crystal display device, compared with synthetic fiber or semisynthetic fiber such as nylon and rayon.

As described above, wear resistance is better in the rubbing cloth made of cotton compared with that of rayon. However, there remains a problem of thicker pile yarns and a lower uniformity of the pile.

As for the rubbing cloth whose pile is made of nylon, wear resistance is superior to that of the rubbing cloth made of rayon or cotton. Thus, the rubbing cloth made of nylon has less occurrence of the cloth debris than the rubbing cloth made of rayon or cotton. However, the rubbing cloth made of nylon has a problem of higher frictional electrification when rubbing than the rubbing cloth made of cotton and rayon. In fact, the rubbing cloth made of nylon becomes charged to a high voltage beyond 2,000 V during rubbing process. Hence, if the rubbing cloth electrically shorts to the substrate in the course of rubbing, this may damage TFT devices and wiring on the substrate.

Moreover, the alignment layer rubbed with the rubbing cloth made of nylon has an insufficient alignment force for a liquid crystal. Therefore, there are problems that the alignment layer gives flowing marks in the liquid crystal when the liquid crystal is injected into the cell, and the response of liquid crystal is slow, which tends to cause a ghost image. As described above, wear resistance is superior in the rubbing cloth made of nylon than that made of rayon. However, the rubbing cloth made of nylon has problems that it is chargeable to a high voltage and has a weak alignment force.

Japanese Patent Application Laid-open No. 7-270798 also discloses that a use of aramid fiber enables improvement in wear resistance of the pile of a rubbing cloth. However, because the aramid fiber is highly crystallized, it is mechanically weak against shear force during a rubbing process even though it has a superior tensile strength, and the fiber tends to break in the lengthwise direction. Thus, there is a problem that fibrils may fall in large quantity due to the breakage in the lengthwise direction and may become debris on the alignment layer.

Japanese Patent Application Laid-open No. 6-194662 still also discloses a use of a rubbing cloth making use of a fibrous-protein material. The fibrous-protein material, however, has poor resistance to heat because it is natural protein like silk, wool and so on. Compared to the thermal-decomposition temperature of rayon that is 260° C. to 300° C., that of the silk is lower by 25° C. to 65° C. As to that of the wool, it is lower by as much as 130° C. to 170° C. Hence, this rubbing cloth may be easily denatured by frictional heat generated by rubbing, and cannot be used as a rubbing cloth.

A rubbing cloth made of casein as a material, as disclosed in Japanese Patent Application Laid-open No. 6-194661, has also the same problem that the frictional heat generated during rubbing may easily denature the casein which is another protein.

An object of the present invention is to provide a method of manufacturing a liquid crystal display apparatus; the method including a rubbing step making use of a rubbing cloth having properties of high wear resistance, low frictional electrification and great alignment force so as to enable manufacture of a highly reliable liquid crystal display apparatus.

To achieve the above object, the present invention provides a liquid crystal display apparatus manufacturing method as described below.

It is a method of manufacturing a liquid crystal display apparatus, comprising a step of rubbing with a rubbing cloth a substrate provided thereon with an alignment layer;

the rubbing cloth comprising a pile portion of raised fibers; the fibers containing a cellulose acetate.

### BRIEF DESCRIPTION OF THE DRAWINGS

These and other features, objects and advantages of the present invention will become more apparent from the following description when taken in conjunction with the accompanying drawings wherein:

FIG. 1 illustrates the step of subjecting an alignment layer on a substrate to rubbing with use of rubbing cloths according to an embodiment of the present invention.

FIG. 2 is a graph showing results obtained by measuring dynamic coefficient of friction in respect of rubbing cloths making use of triacetate fibers according to an embodiment of the present invention and rubbing cloths of comparative examples.

FIG. 3 schematically illustrates the construction of an apparatus used to measure the dynamic coefficient of friction shown in FIG. 2.

FIG. 4 is a graph showing results obtained by measuring debris sticking levels on substrate in respect of rubbing cloths making use of triacetate fibers according to an embodiment of the present invention and rubbing cloths of comparative examples.

FIG. 5 is a graph showing results obtained by measuring frictional electrification voltage on rubbing cloth during rubbing process, in respect of rubbing cloths making use of triacetate fibers according to an embodiment of the present invention and rubbing cloths of comparative examples.

FIG. 6 is a graph showing the relationship between the optical anisotropy of an alignment layer and the angle of rotation of an alignment layer sample.

FIG. 7 is a graph showing the relationship between the optical anisotropy of alignment layers rubbed with a rubbing cloth making use of triacetate fibers according to an embodiment of the present invention and rubbing cloths in the comparative examples, and the dynamic coefficient of friction of the rubbing cloths.

FIG. 8 is a graph showing results obtained by measuring frictional electrification voltage on the test substrate when rubbing, in respect of rubbing cloths making use of triacetate fibers according to an embodiment of the present invention and rubbing cloths of comparative examples.

### DETAILED DESCRIPTION OF THE INVENTION

A liquid crystal display apparatus manufacturing method according to an embodiment of the present invention is described below.

The liquid crystal display apparatus manufacturing method comprises a rubbing step. In this rubbing step, a rubbing cloth is used as described below.

Manufacture of Rubbing Cloth:

The present inventors have manufactured rubbing cloths by way of trial experiments, using various fiber materials, and made extensive evaluation studies. As the result, they have discovered that the use of acetate fibers in the pile portion makes it possible to obtain a rubbing cloth having properties of great alignment force, low frictional electrification and high wear resistance. This rubbing cloth is specifically described below.

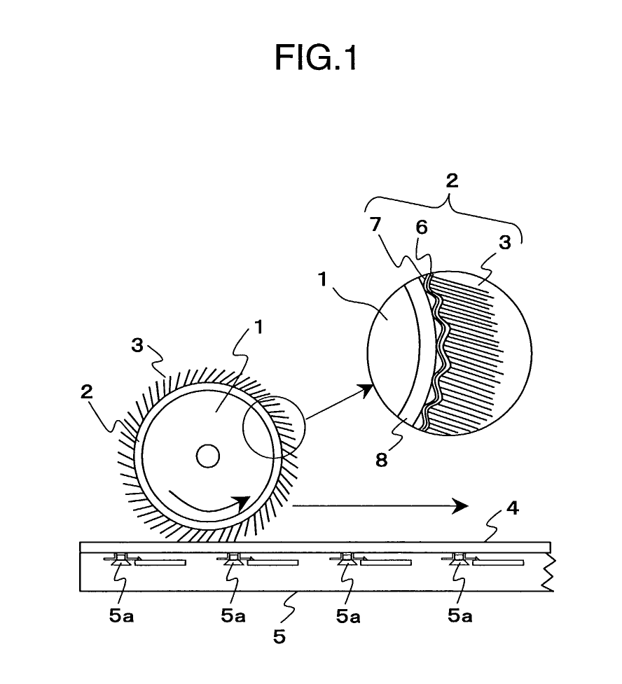

As shown in FIG. 1, a rubbing cloth 2 according to this embodiment is a raised cloth having pile 3 with raised fibers, a ground sheet 6 to which the pile is fastened, and a back coat layer 7. Pile yarn constituting the pile 3 contains acetate fibers.

The acetate fibers are fibers made of cellulose acetate, which is represented by the following chemical formula:

[C₆H₇O₂(OCOCH₃)ₓ(OH)₃₋ₓ]ₙ

wherein 0<x≦3.

Cellulose acetates having any acetylation degree may be used as long as they can be processed into fibers. For example, cellulose acetates having an acetylation degree of 45% (x=1.8) or more may be used. Specifically, cellulose triacetate and cellulose diacetate may be used. Here, fibers made of cellulose triacetate (hereinafter “triacetate fibers”) are used as the acetate fibers.

In this embodiment, used are fibers obtained by subjecting filaments of acetate fibers to crimping in a spiral fashion (spiral buckling process) by the false twist method to make them into filament textured yarn.

The acetate fibers contained in the pile yarn may preferably comprise 20% or more of the whole pile yarn from the viewpoint of effectiveness. For example, the pile 3 may be made up using a blend of acetate fibers and other fibers. In addition, only the end of the pile 3, which comes into direct contact with the alignment layer during rubbing process, may be made up using acetate fibers or the blend of acetate fibers and other fibers.

In this embodiment, three kinds of rubbing cloths are prepared, the entire pile 3 of which is constituted of triacetate fibers, i.e., having pile 3 made of 100% triacetate fibers. The three kinds of rubbing cloths are made up as shown in Table 1, Nos. 1 to 3.

Each filament of the acetate fibers may preferably have a thickness from 1 denier to 5 deniers. In this embodiment, filaments having 3.75 deniers are used. Much thicker filaments or thiner filaments may also be selected. However, if the filaments have a thickness of 0.5 denier or less, the pile 3 may be scarcely raised, and this may require additional treatment like resin dipping or blending of thick fibers to keep the piles.

At the time of weaving, pile yarn obtained by twisting the above filaments in a stated number into yarn may be used as the pile yarn to be used as the yarn for making up the pile. In this embodiment, three kinds of rubbing cloths are prepared, i.e., rubbing cloths comprised of pile yarn obtained by twisting twenty triacetate fibers having a filament thickness of 3.75 deniers with different ground yarn density or cloth thickness and so forth (Nos. 1 to 3 in Table 1).

TABLE 1

| | | | GROUND | | | NUMBER |
|---|---|---|---|---|---|---|
| | | | YARN DENSITY | | CLOTH | OF FIBERS |
| | TYPES OF | PILE YARN | (FIBERS/cm²) | | THICKNESS | IN PILE |
| No. | VELVET | (DENIERS/FIBERS) | WARPS | WEFTS | (mm) | (FIBERS/cm²) |
| 1 | TRIACETATE 1 | TRIACETATE FALSE- | 23.1 | 49.5 | 1.9 | 15,240 |
| | | TWIST YARN | | | | |
| | | (75/20) | | | | |
| 2 | TRIACETATE 2 | TRIACETATE FALSE- | 23.1 | 49.5 | 2.2 | 15,240 |
| | | TWIST YARN | | | | |
| | | (75/20) | | | | |
| | | TRIACETATE FALSE- | 15 | 25 | 1.8 | 15,000 |
| | TRIACETATE 3 | TWIST YARN | | | | |
| | | (75/20) | | | | |
| 4 | POLYESTER | REGULAR POLYESTER | 17.5 | 54.5 | 1.8 | 45,720 |
| | | (150/72) | | | | |
| 5 | RAYON | RAYON | 17.5 | 60.0 | 1.8 | 28,000 |
| | | (100/40) | | | | |
| 6 | COTTON | COTTON | 19 | 29 | 2.2 | — |
| | | (#40 PLIED YARN) | | | | |
| | | (ABOUT 265 DENIERS) | | | | |
| 7 | POLYNOSIC | POLYNOSIC | 19 | 31 | 2.1 | — |
| | | (#40 PLIED YARN) | | | | |
| | | (ABOUT 265 DENIERS) | | | | |
| 8 | NYLON | NYLON | 33 | 44 | 1.9 | 21,780 |
| | | (100/30) | | | | |
| 9 | VINYLON | VINYLON | 23.1 | 39.6 | 1.8 | 30,500 |
| | | (140/50) | | | | |

The rubbing cloth may also have any cloth weave as long as it is a raised cloth or fabric, and may have warp-pile texture in which the pile yarn constituting the pile forms warps, or weft-pile texture in which it forms wefts. In this embodiment, the rubbing cloths of Nos. 1 and 2 in Table 1 have cloth texture of velvet. The rubbing cloth of No. 3 in Table 1 has the cloth texture of tricot that is a warp knit where the pile loops have been cut and raised. Besides these, usable are moquette, double raschel, and a sinker loop of circular -knitted fabric which have been subjected to shearing.

The ground yarn constituting the ground sheet 6 to which the pile 3 is to be fastened, is not a portion with which the alignment layer is directly rubbed in the rubbing process, and hence may be made of any material to which the pile can be fastened. In the rubbing cloths of Nos. 1 and 2 in this embodiment, fibers made of polyester are used for both the warps and the wefts. Besides the polyester fibers, usable are cellulose acetate fibers, cotton fibers, rayon fibers, polyamide fibers, polyester fibers, acrylic fibers and aramid fibers. The ground yarn may also have any thickness which enables the pile yarn to be fastened thereto.

In this embodiment, in both the rubbing cloths of Nos. 1 and 2, those obtained by twisting two polyester filaments of 50 deniers to have a thickness of 100 deniers are used as ground yarn warps and those obtained by follow-up twisting of polyester filaments of 75 deniers are used as ground yarn wefts.

The density of triacetate fibers (filaments) constituting the pile 3 may preferably be at least 5,000, and more preferably 10,000 fibers or more, per square centimeter. If the number of filaments per square centimeter is less than 5,000, the number of filaments with which the alignment layer is rubbed is so small as to result in non-uniform rubbing, making it impossible to perform proper aligning treatment.

The upper limit of the number of filaments in an unit area depends on manufacturability of the rubbing cloth. Depending on the thickness of filaments, about 500,000 fibers per square centimeter are the upper limit of the number of filaments. In this embodiment, in all the rubbing cloths Nos. 1 to 3 in Table 1, the cloths are so woven that the pile 3 has a filament density of about 15,000 fibers per square centimeter, where the filaments of the pile 3 are a little tilted and thereafter so arranged as to stand in lines in substantially the same direction.

The cloth thickness extending from the ground sheet 6 to the end of the pile 3 may be 1.2 mm or more to 3.5 mm or less as thickness in the state the filaments of the pile 3 are tilted. In this embodiment, the cloth thickness ranges from 1.8 mm to 2.2 mm (Nos. 1 to 3 in Table 1). Any scattering in thickness of the cloth in its in-plane direction may preferably be controlled within a tolerance (common difference) of 0.3 mm.

A method of manufacturing the rubbing cloth of this embodiment is described below.

Firstly, gray yarn triacetate fibers (filaments) of a stated thickness were bundled into the number of fibers shown in Table 1 and were subjected to crimping by the false twist method. The fibers were treated with dry heat or wet heat to set crimps under the false-twisted state which was provided by false-twist machine, followed by untwisting to prepare pile yarn. By this treatment, in the triacetate fibers constituting the pile yarn, individual filament was crimped in a spiral form.

Next, to the pile yarn, a sizing agent mainly composed of polyvinyl alcohol which is used in usual velvet process, was applied with a slasher sizing machine. Using the pile yarn thus sized and the above polyester ground yarn, a velvet fabric was woven. The velvet fabric was formed in a known texture called fast pile, in which two of pile yarn are placed in a row for one warp ground yarn and these pile yarns are fixed with three weft ground yarns. Here, the cloth was so woven that the triacetate fibers of the pile 3 were in a filament density of about 15,000 fibers per square centimeter as described above.

Pile yarn of the cloth thus obtained by weaving were cut and raised, and then the piles were cut to an even length by shearing, followed by desizing and scouring (cleaning and so forth). After drying, the piles were brushed. Thus, the piles made of triacetate filaments which are twisted up became loose to provide individually raised filaments of the state of pile 3 in FIG. 1. Thereafter, the filaments of the pile 3 were slightly tilted and thereafter so arranged as to stand in lines in substantially the same direction.

Next, a resin was coated on the back of the ground sheet 6, followed by baking to form a back coat layer 7. This back coating has been done in order to prevent the fibers of the pile portion from coming off during rubbing and also to prevent the rubbing cloth from being wrinkled when attached to a rubbing roller 1 as shown in FIG. 1. This is an indispensable step for the velvet to be used as the rubbing cloth. As the resin used to form the back coat layer 7, acrylic resin, polyvinyl acetate resin or the like may be used. Here, a resin material mainly composed of an acrylic resin was coated on the back of the ground sheet 6 by knife coating to form the back coat layer 7 comprised of the acrylic resin.

Thus in this embodiment, the pile yarn which utilizes the stated number of false-twisted and heated filaments have been successfully applied to manufacture the rubbing cloth having the pile 3 where individual filaments stand on end in the desired filament density. This is due to the weaving process carried out using the pile yarn whose filaments are bundled and false-twisted and then heated to bring them into a state where the crimps are set to the filaments.

For example, when you use pile yarn subjected only to the false twisting without thermosetting of crimps, the cloth manufacture itself is not impossible. However, in a heating step (e.g., resin back coating on the ground sheet) included in velvet production, the pile yarn may get crimped and shrinks finally providing a felt-like texture with increased fiber density.

Accordingly, in order to form the pile 3 whose individual filaments stand on end, which is preferable for the rubbing cloth, it is desirable to use the pile yarn whose filaments are false-twisted and then heated to set the crimps as demonstrated in this embodiment.

As comparative examples, rubbing cloths having pile 3 comprised of fibers of rayon, cotton, polynosic, polyester, nylon and vinylon, were also prepared in substantially the same manner. By the way, in the case of cotton and polynosic cloths, spun yarn was used instead of filaments. Manufacturing conditions for the rubbing cloths of comparative examples are summarized as from No. 4 to 9 in Table 1.

(Evaluation 1 of Rubbing Cloth: Alignment Force)

Next, in respect of the three kinds of rubbing cloths making use of triacetate fibers according to this embodiment (Nos. 1 to 3 in Table 1) and the rubbing cloths of comparative examples (Nos. 4 to 9 in Table 1), their liquid crystal molecule alignment force was evaluated.

First, a substrate 5 with an alignment layer 4 to be subjected to rubbing was manufactured. Here, as the substrate 5, two types were prepared, a glass substrate (TFT substrate) of 10 cm square which was provided with thin-film transistor driving devices (TFT) 5a previously formed as shown in FIG. 1, and a glass substrate (ITO substrate) of 10 cm square on which an ITO (indium-tin oxide) film was previously formed. On each of these two types of substrates 5, a polyimide precursor solution was coated, followed by baking at 200° C. to 300° C. to form an alignment layer 4 made of polyimide.

Meanwhile, rubbing cloths 2 of this embodiment and comparative examples were each fastened with a doubleside adhesive tape 8 to a rubbing roller 1 of 50 mm diameter, made of stainless steel, and this roller was attached to a rubbing machine.

Rotating the rubbing roller 1 at a speed of 1,500 rpm on the rubbing machine, the pile 3 of the rubbing cloth 2 was brought to contact with the alignment layer 4. Then, the pile 3 was pressed against the surface of the alignment layer 4 to have 0.5 mm decrease in the distance between the rubbing-roller-surface and the alignment-layer-surface. (This state is herein called “pile compression depth of 0.5 mm”) In this state, a stage with the substrate 5 placed thereon was moved in a fixed direction at a rate of movement of 30 mm/sec to perform rubbing process. This rubbing process was performed on TFT substrates 5 and ITO substrate 5 for one kind of rubbing cloth, and thereafter these two substrates 5 were put together, bringing their alignment layers 4 to face to each other in such a way that the rubbing directions stood anti-parallel. Thus, a liquid crystal cell was formed. Then, a liquid crystal was put into the gap between the two substrates 5 and was sealed between them. Final liquid crystal cell gap was about 5 μm.

The liquid crystal cell thus formed was inserted between two polarizing plates, and light was transmitted therethrough to make observation on how liquid crystal molecules were aligned. As the result, in the case of the three kinds of rubbing cloths made of triacetate fibers according to this embodiment (Nos. 1 to 3 in Table 1) and the rubbing cloths made of rayon and cotton according to comparative examples (Nos. 5 and 6 in Table 1), the liquid crystal in the cell were found to have uniform alignment, achieving a sufficient alignment force. On the other hand, in the case of the rubbing cloths made of polyester, nylon and vinylon (Nos. 4, 8 and 9 in Table 1), it was found that the flowing mark of the liquid crystal remained in the cell when liquid crystal was injected into the cell and the cell was sealed, whereby showing a weak alignment force for the liquid crystal.

It was also found that, in the case of the three kinds of rubbing cloths made of triacetate fibers according to this embodiment (Nos. 1 to 3) and the rubbing cloth made of polynosic according to comparative example (No. 7), the liquid crystal in the liquid crystal cell were more uniformly aligned, showing a greater alignment force than the rubbing cloths made of rayon and cotton according to comparative examples (Nos. 5 and 6).

(Evaluation 2 of Rubbing Cloth: Dynamic Coefficient of Friction)

The present inventors have presumed that there should be some correlation between the frictional force of the rubbing cloth 2 with the alignment layer 4 and the alignment force. Because the rubbing utilizes the tribological interaction between the rubbing-cloth-pile 3 and the alignment layer 4 to make one dimensional molecular order in the polymer film of the alignment layer which in turn regulates the molecular order in the liquid crystal. Accordingly, the dynamic coefficients of friction of the rubbing cloths of this embodiment and comparative examples with the alignment layers were measured. Those were measured with the Surface Property Tester (TYPE 14DR) manufactured by Shinto Scientific Co., Ltd.

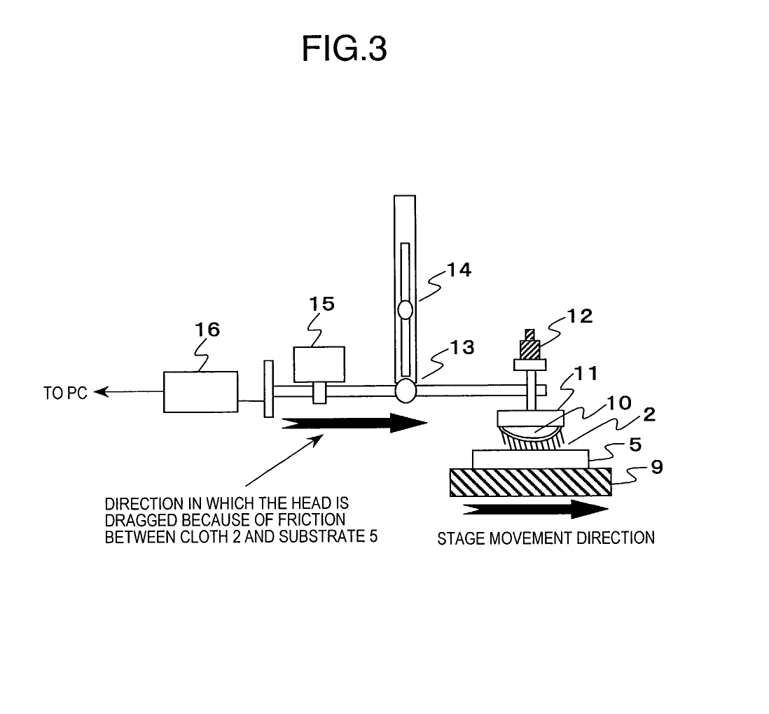

This surface property measuring instrument has, as shown in FIG. 3, a head 11 to which a rubbing cloth to be measured is attached, a balancing load 15 which balances the head 11 on supports 13 and 14 at the center, a stage 9 to which a substrate 5 having an alignment layer (hereinafter simply “substrate 5”) is fixed, and a load transducer 16. To the head 11, a jig 10 of the same curvature radius (R=25 mm) as that of the 50 mm-diameter roller 1, is attached. To this jig 10, the rubbing cloth 2 to be measured, having been cut out in 30 mm square was fastened with a doubleside adhesive tape.

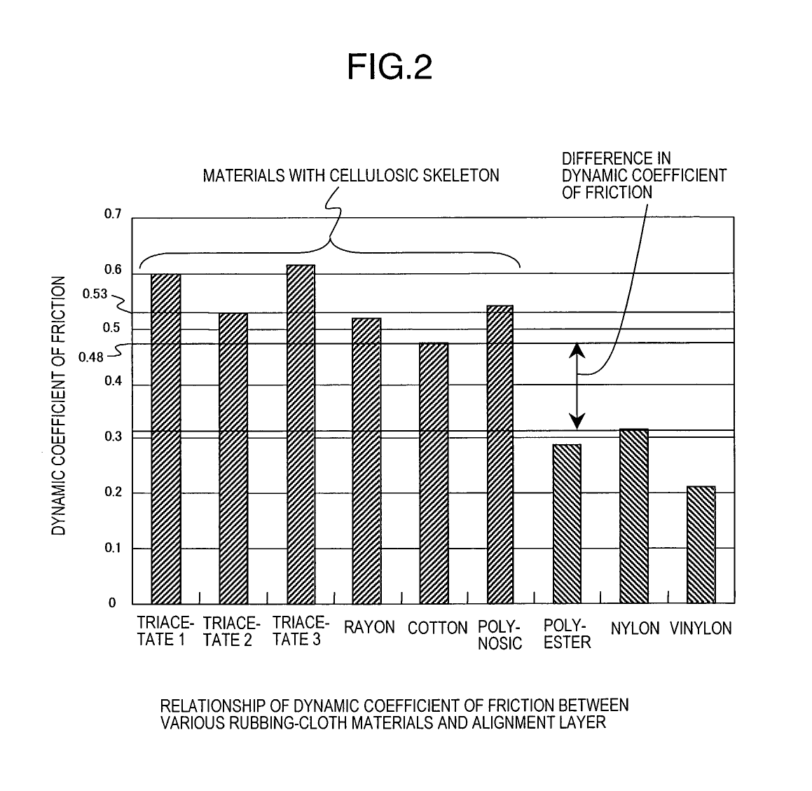

The rubbing cloth 2 was attached in such a direction that its warps were in parallel to the direction of movement of the substrate 5. The rubbing cloth 2 was brought into contact with the substrate 5, and a vertical load of 50 g was applied onto the head 11 by a loading weight 12. Then the substrate 5 was moved at the rate of 5 mm/sec, where the frictional force between the rubbing cloth 2 and the substrate 5 was measured by monitoring the pull force on the head 11 using a personal computer (not shown) through the load transducer 16. The results obtained are shown in FIG. 2.

As can be seen from FIG. 2, the three kinds of rubbing cloths making use of triacetate fibers according to this embodiment (Nos. 1 to 3) and the rubbing cloths made of rayon, cotton and polynosic according to comparative examples (Nos. 5, 6 and 7) show a dynamic coefficient of friction of 0.48 or more, which is 0.31 or less in the cases of nylon and polyester. These rubbing cloths having the dynamic coefficient of friction of 0.48 or more are in agreement with the rubbing cloths having been judged to have a sufficient alignment force, from the observation of the alignment state of liquid crystal.

Among the rubbing cloths having the dynamic coefficient of friction of 0.48 or more, the three kinds of rubbing cloths making use of triacetate fibers according to this embodiment (Nos. 1 to 3) and the rubbing cloth made of polynosic (No. 7) have a dynamic coefficient of friction of 0.53 or more, showing an especially large dynamic coefficient of friction. These are in agreement with the rubbing cloths having been judged to have an especially great alignment force, from the observation of the alignment state of liquid crystal. As can be seen from these facts, there is a positive correlation between the alignment force and the dynamic coefficient of friction, and the use of the rubbing cloths having the dynamic coefficient of friction of 0.53 or more brings about a greater alignment force than that of any conventional rubbing cloths.

(Evaluation 3 of Rubbing Cloth: Optical Anisotropy of Alignment Layer)

Next, in respect of the alignment layers subjected to rubbing with the rubbing cloths making use of triacetate fibers according to this embodiment (No. 1 in table 1), its optical anisotropy, which is an index of alignment characteristics, was measured.

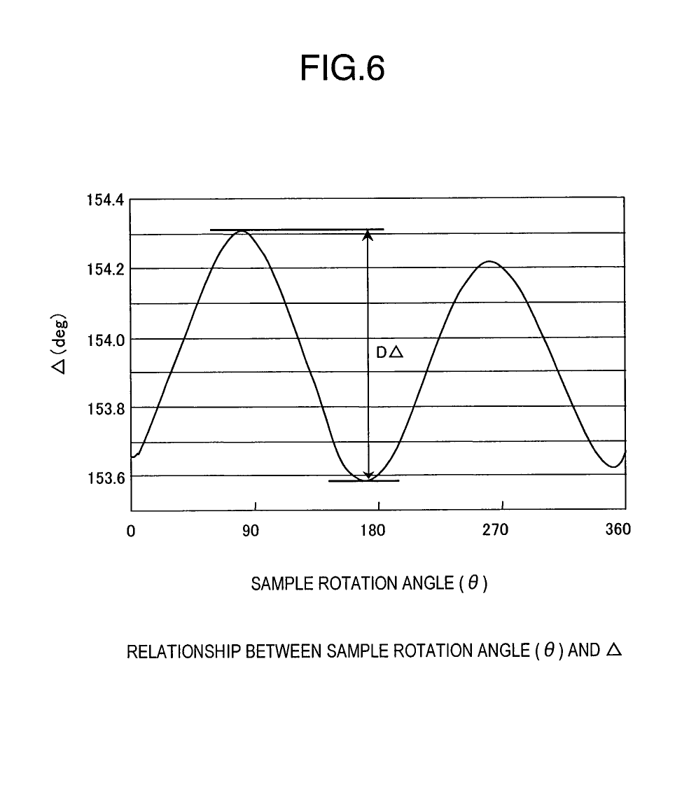

In general, the rubbing of an alignment layer causes anisotropy in dielectric constant (refractive index) between the rubbing direction and the direction perpendicular to the rubbing direction. Accordingly, the measuring of phase difference (phase shift) (Δ) between a P-wave and an S-wave by ellipsometry while rotating an alignment layer sample and the plotting of Δ with respect to a rotation angle (θ) of the sample give a curve as shown in FIG. 6. The difference between the maximum value and the minimum value in this curve, DΔ, can be used as an index of optical anisotropy of the alignment layer. It is known that, the larger the DΔ is, the greater the index of optical anisotropy of the alignment layer has been made by the rubbing, as can be so evaluated (e.g., I. Hirosawa, Jpn. J. Appl.

Phys. 36, 5192, 1997; I. Hirosawa, T. Matsushita, H. Miyairi and A. Saito, Jpn. J. Appl. Phys. 38, 2851, 1999).

Accordingly, in respect of alignment layers having been subjected to rubbing with the rubbing cloth making use of triacetate fibers according to this embodiment (No. 1 in Table 1) and the rubbing cloths made of polyester, rayon and cotton according to comparative examples (Nos. 4, 5 and 6 in table 1), their DA was measured. For the measurement, used was a liquid crystal alignment layer evaluation instrument PI-Checker, Model PI-φ280, manufactured by Toyo Corporation, which is an instrument for measuring the index of optical anisotropy of the alignment layer by the above principle. As rubbing objects, used was the substrate 5 on which the alignment layer 4 was formed (see FIG. 1) like that used in the evaluation 1 described above. The alignment layer 4 was formed in the same manner as in the evaluation 1 (description is not repeated). Also, the rubbing cloths were, like those in the evaluation 1, each fastened to the rubbing roller 1, made of stainless steel, and this roller was attached to the rubbing apparatus. The rubbing was performed under conditions of a number of roller revolutions of 1,500 rpm, a pile compression depth of 0.5 mm of the pile end to the alignment layer, and a rate of stage movement of 30 mm/sec.

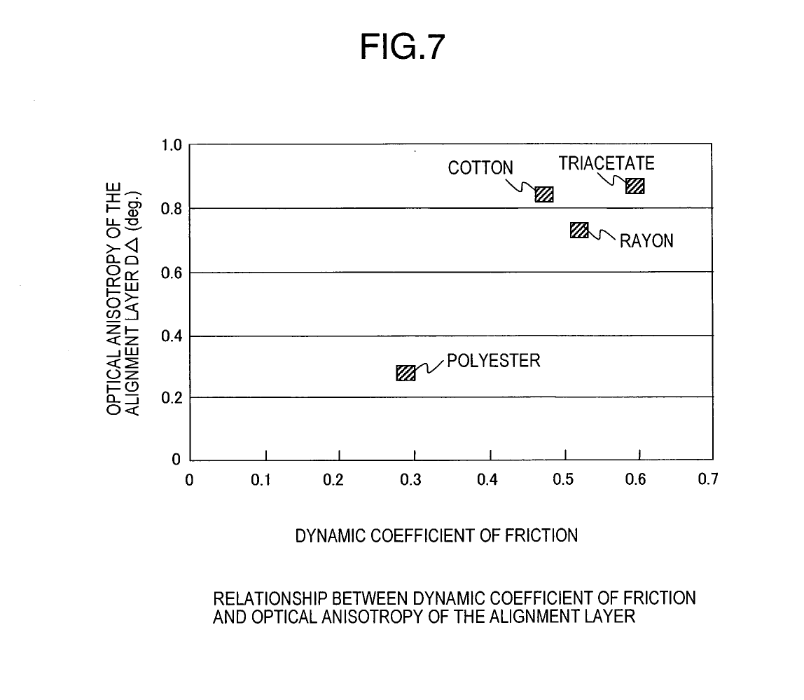

In respect of the alignment layer 4 subjected to rubbing, the index of optical anisotropy of the alignment layer was measured with the above instrument. As the result, as shown in FIG. 7, the alignment layer 4 subjected to rubbing with the rubbing cloth making use of triacetate fibers according to this embodiment (No. 1) showed the greatest DΔ, which was 0.85 degree or more. Next thereto was the rubbing cloth made of cotton according to a comparative example (No. 6), and then the rubbing cloth made of rayon (No. 5). The rubbing cloth made of polyester (No. 4) showed the smallest value.

Thus, from the results of measurement of the index of optical anisotropy of the alignment layer DΔ it was ascertained that the rubbing cloth making use of triacetate fibers according to this embodiment (No. 1) had a greater alignment force than those of comparative examples.

FIG. 7 also shows the relationship of correspondence between the measured values of DΔ and the dynamic coefficient of friction measured in the above evaluation 2. From FIG. 7, it can be ascertained that the index of optical anisotropy of the alignment layer increases with an increase in the dynamic coefficient of friction. This has proved that a great alignment force can be achieved by the rubbing performed using, as stated in the in the evaluation 2, the rubbing cloth whose pile is constituted of the material with a cellulosic skeleton, having a large dynamic coefficient of friction.

As stated also in the evaluation 2, among various rubbing cloths inclusive of those of comparative examples, the rubbing cloths making use of triacetate fibers according to this embodiment (Nos. 1 to 3) show the largest dynamic coefficient of friction (FIG. 2). Thus, it has become more clear that these are superior as rubbing cloths which endow the alignment layer with the force to control the alignment of liquid crystal molecules.

(Evaluation 4 of Rubbing Cloth: Wear Resistance)

Next, wear resistance was evaluated for the three kinds of rubbing cloths making use of triacetate fibers according to this embodiment (Nos. 1 to 3) and the rubbing cloths made of rayon and cotton according to comparative examples (Nos. 5 and 6).

Firstly, rubbing cloths 2 to be tested were fixed with a doubleside adhesive tape on the rubbing roller 1 of 50 mm diameter, made of stainless steel, and attached to the rubbing machine, as shown in FIG. 1. Chromium (Cr) coated glass substrates of 10 cm square repeatedly rubbed 200 times with the rubbing cloths at the rotating speed of 1,500 rpm, the pile compression depth of 0.5 mm, and the stage movement rate of 30 mm/sec. The external appearance of rubbed Cr surface was observed under an optical microscope, and its image was captured with a CCD camera to quantify pile debris sticking levels.

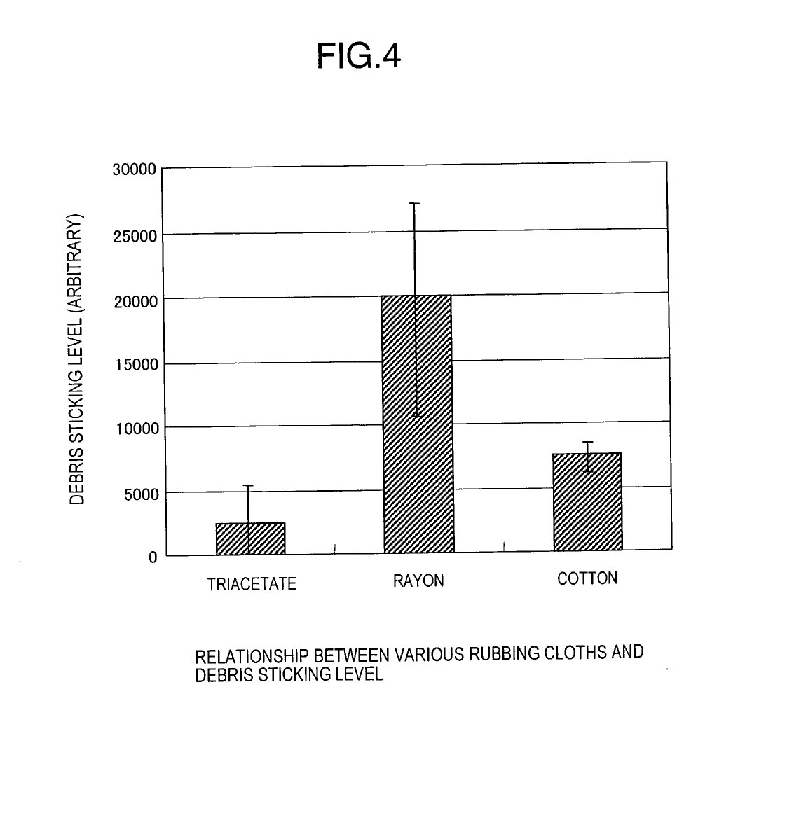

As the result, the debris sticking levels of the rubbing cloths made of triacetate fibers according to this embodiment (Nos. 1 to 3) were found to be smallest, and the debris sticking level was found to be larger in the order of the rubbing cloth made of cotton and the one made of rayon, which were as shown in FIG. 4. In FIG. 4, the debris sticking level shown for “triacetate” is shown as an average of measurement results on the three kinds of rubbing cloths according to this embodiment (Nos. 1 to 3).

As shown in FIG. 4, it has been found that the rubbing cloths made of triacetate fibers according to this embodiment have a higher wear resistance and greatly smaller debris sticking level on substrate than the rubbing cloths made of rayon and cotton according to comparative examples.

(Evaluation 5 of Rubbing Cloth: Frictional Electrification Voltage of Rubbing Cloth)

The frictional electrification during rubbing has so large a potential as to cause electrostatic break of TFT devices fabricated on TFT substrates. Hence, it is desirable for such electricity not to be generated as far as possible. In common textile engineering, triacetate fibers are known to have higher potential to cause electrostatic problems than rayon or cotton fibers. The electrostatic voltages generated on the rubbing roller (cloth) had been measured during rubbing process. The voltages for the rubbing cloths made of triacetate fibers according to this embodiment (Nos. 1 to 3) and the rubbing cloths made of rayon, cotton and nylon according to comparative examples (Nos. 5, 6 and 8) had been measured and compared.

Firstly, under the same conditions as those for the alignment force estimation in the evaluation 1, the alignment layer 4 on the substrate 5 was subjected to rubbing process as shown in FIG. 1. Here, a glass substrate manufactured by Corning Inc. was used as the glass substrate and SE-7492, available from Nissan Chemical Industries, Ltd., was used as the polyimide precursor solution. The rubbing conditions were the same as those for the evaluation 1, that is, the roller rotating speeed of 1,500 rpm, the pile compression depth of 0.5 mm, and the stage movement rate of 30 mm/sec.

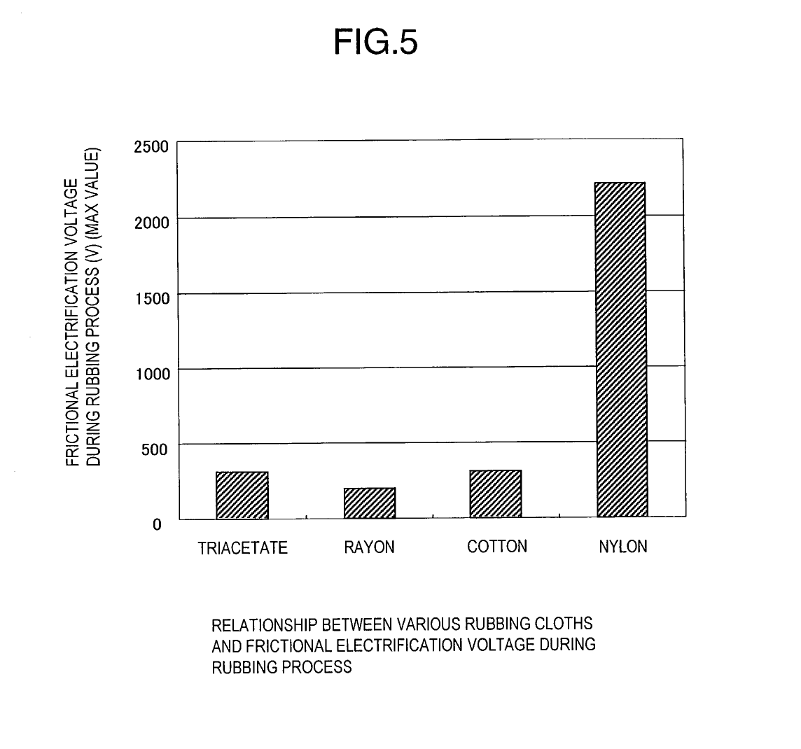

The roller (cloth) surface potential during the rubbing was measured and shown in FIG. 5. The rubbing cloth made of nylon according to comparative example (No. 8) showed the frictional electrification voltage of 2,000 V or more. On the other hand, the rubbing cloths made of triacetate fibers according to this embodiment (Nos. 1 to 3) showed a frictional electrification voltage lower than 500 V, comparable to that of the rubbing cloths made of rayon and cotton according to comparative examples (Nos. 5 and 6).

In FIG. 5, the frictional electrification voltage of the rubbing cloth made of triacetate fibers is an average of the data measured on the rubbing cloths of Nos. 1 to 3 in Table 1. Substrates having TFT devices on the surfaces were also subjected to rubbing with the rubbing cloths made of triacetate fibers according to this embodiment (Nos. 1 to 3). As the result, any electrostatic break of TFT devices was not seen.

Thus, it has been found that the frictional electrification voltage of the rubbing cloths made of triacetate fibers according to this embodiment is comparable to that of the rubbing cloths made of rayon and cotton which have been conventionally used. That is, the invented triacetate cloths show as low electrification voltage as rayon and cotton which is practically usable level without causing electrostatic damage on the TFT devices. Incidentally, instead of triacetate fibers, diacetate fibers may be used to make up the pile 3, which is expected to offer a lower voltage of frictional electrification.

(Evaluation 6 of Rubbing Cloth: Frictional Electrification Voltage of Test Substrate)

The frictional electrification produced on the TFT substrate 5 when rubbing comes released from areas between the driving devices 5a and between wirings thereby to cause defects in the liquid crystal display apparatus. Hence it must be more kept from being produced than the frictional electrification of the rubbing cloth. Accordingly, the substrate was subjected to rubbing with the rubbing cloths made of triacetate fibers according to this embodiment (Nos. 1 to 3 in Table 1) and the rubbing cloths made of rayon and cotton according to comparative examples (Nos. 5 and 6 in table 1), and their frictional electrification voltage on the substrate was measured.

The substrate used for measurement is a glass substrate of 10 cm square which is provided at its center with an ITO film (transparent conductive film) of 5.5 cm square and on the whole surface of which the polyimide alignment layer is so formed as to cover the ITO film. Since in this way the ITO film is held between the glass substrate and the alignment layer, the inside of the region where the ITO film is present comes to have substantially a constant potential. Hence, a stable surface potential can be measured and also it follows that a quasi TFT substrate is reproduced. This enables measurement of the frictional electrification voltage of the substrate in a condition close to that of a substrate of an actual liquid crystal display apparatus. Here, to obtain the glass substrate provided with the ITO film only at the center area, an ITO film was previously formed on the whole surface of a substrate and then the ITO film was partially etched away.

The alignment layer was formed using SE-7492, available from Nissan Chemical Industries, Ltd., as the polyimide precursor solution like that in the evaluation 5, and in the same manner as the alignment layer 4 in the evaluation 1. The rubbing was performed under conditions of, like those in the evaluation 5, a number of roller revolutions of 1,500 rpm, a pile compression depth of 0.5 mm of the pile end to the alignment layer, and a rate of stage movement of 30 mm/sec.

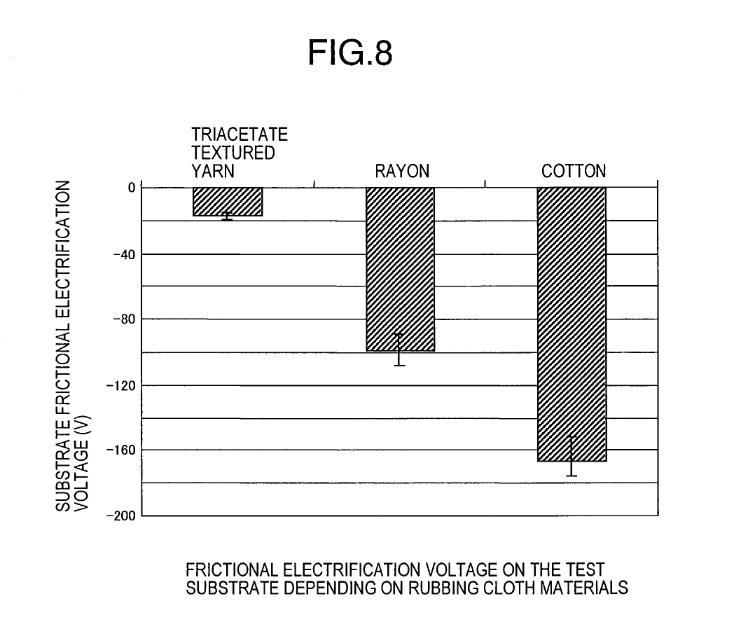

After the rubbing, the surface potential of the alignment layer at the substrate center was measured. As the result, as shown in FIG. 8, the frictional electrification voltage of the substrate subjected to rubbing with the rubbing cloth made of cotton according to comparative example (No. 6) was the highest, and the frictional electrification voltage of the substrate subjected to rubbing with any of the rubbing cloths made of triacetate fibers according to this embodiment (Nos. 1 to 3) was lowest. In FIG. 8, the data shown as “triacetate” is shown as an average of frictional electrification voltages of substrates subjected to rubbing with the three kinds of rubbing cloths made of triacetate fibers according to this embodiment (Nos. 1 to 3).

Thus, the rubbing cloths made of triacetate fibers according to this embodiment (Nos. 1 to 3) were found to bring about a lower frictional electrification voltage on the substrate when rubbing, than those of comparative examples. Also, alignment layers 4 of substrates 5 provided with driving devices (TFT) 5a were also subjected to rubbing with the rubbing cloths made of triacetate fibers according to this embodiment, to find that any particular break of the driving devices (TFT) 5a was not seen.

As having been described above, in this embodiment, the use of triacetate fibers in the part of the pile 3 of the rubbing cloth 2 can provide the rubbing cloth having properties of greater alignment force, high wear resistance and low frictional electrification. Thus, the use of the rubbing cloth made of acetate according to this embodiment offers improvement for the weak point of the conventional rayon-made rubbing cloth that the wear resistance is low although alignment force is high and frictional electrification is low. Moreover, it also enables the rubbing process with less debris due to higher wear resistance, affording a great alignment force and hardly causing the break of TFT devices due to low frictional electrification.

Incidentally, although the triacetate fibers are commonly thought to have not so high wear resistance and also cause a high frictional electrification, the above evaluation tests have proved that the rubbing cloth making use of triacetate fibers according to this embodiment has the properties of high wear resistance and low frictional electrification. The reason why it has such properties is unclear in detail. It is presumed that, since the triacetate fibers constituting the pile 3 have been subjected to crimping, the pile makes numerous point contacts with the alignment layer on the substrate and has additional elasticity behaving like a spiral spring, and hence may have exceptionally high resistance to wear. It is also presumed that since the crimps enhance mutual point contacts between filaments everywhere the electrostatic charge generated on the pile surface may readily escape through the number of point contacts.

In this embodiment, the filaments have spiral-shape crimps introduced by the false twist method. Texturing methods are by no means limited to the false twist method. Also usable are a method in which filaments are hard twisted and then heated to set the twists by heat, followed by untwisting to texture the filaments in a spiral fashion, or a scratch method in which filaments are scratched to texture them into gentle coils.

In addition, the textured form added to filaments is by no means limited to the spiral-shape, and the filaments may have any form as long as it is a non-linear form. For example, filaments textured in a zigzag fashion may be used. The usable means are a forcing method in which filaments are forced into a box while being buckled, or a gear method in which filaments are passed through between two gears so as to be tooth-marked, followed by thermal setting. Filaments textured by a knit-deknit method in which filaments are first knitted and set by heat followed by disentangling may also be used.

In the embodiment described above, the rubbing cloth comprises the pile made up using fibers of cellulose acetate formed by substituting at lest part of hydroxyl groups of cellulose with an acetyl group. The present invention is by no means limited thereto, and may be any of those in which the fibers used in the pile portion contains fibers of a cellulose derivative. In the case when such fibers of a cellulose derivative is used, textured yarn whose fibers have been subjected to crimping can be formed in the same manner as the cellulose acetate fibers described above.

For example, as the cellulose derivative, a cellulose ester derivative represented by the following chemical formula (1) may be used, which has ester linkages to hydroxyl groups of cellulose.

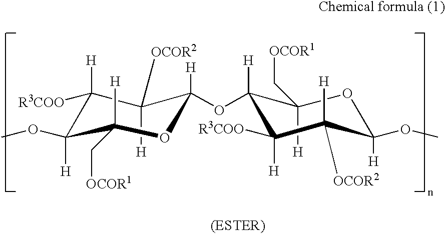

wherein R¹, R² and R³ are each any of a saturated hydrocarbon group having 1 to 18 carbon atoms, an unsaturated hydrocarbon group having 2 to 18 carbon atoms, a cycloalkyl group having 3 to 8 carbon atoms, a fluoroalkyl group having 1 to 18 carbon atoms, a hydroxyalkyl group having 2 to 18 carbon atoms, a cyanoalkyl group having 2 to 18 carbon atoms, a carboxyalkyl group having 1 to 18 carbon atoms, an organic group having 6 to 25 carbon atoms which has an aryl group and an alkyl group simultaneously, an aryl group having 5 to 25 carbon atoms which contains a hetero atom, an organic group having 6 to 25 carbon atoms which contains a hetero atom and has an aryl group and an alkyl group simultaneously, and a cycloalkyl group having 3 to 8 carbon atoms which contains a hetero atom.

Stated specifically, R₁, R₂ and R₃ may each be any of methyl, ethyl, propyl, vinyl, cyclopropyl, cyclobutyl, cyclopentyl, cyclohexyl, trifluoromethyl, tetrafluoroethyl, ethoxyethyl, oxyethyl, cyanoethyl, carboxymethyl, carboxyethyl, phenyl, phenylmethyl, tolyl, naphthyl, naphthylmethyl, pyridyl, pyridylmethyl, pyrimidyl, pyrimidylmethyl, quinolyl, quinolylmethyl, imidazolyl, imidazolylmethyl, furyl and thienyl groups.

As the cellulose derivative, a cellulose ether derivative represented by the following chemical formula (2) may also be used, which has ether linkages to hydroxyl groups of cellulose.

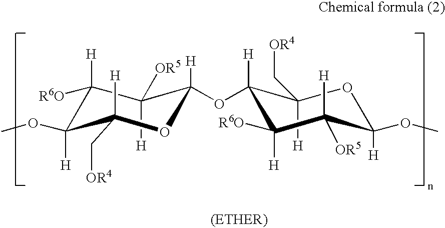

wherein R⁴, R⁵ and R⁶ are each any of a saturated hydrocarbon group having 1 to 18 carbon atoms, an unsaturated hydrocarbon group having 2 to 18 carbon atoms, a cycloalkyl group having 3 to 8 carbon atoms, a fluoroalkyl group having 1 to 18 carbon atoms, a hydroxyalkyl group having 2 to 18 carbon atoms, a cyanoalkyl group having 2 to 18 carbon atoms, a carboxyalkyl group having 1 to 18 carbon atoms, an organic group having 6 to 25 carbon atoms which has an aryl group and an alkyl group simultaneously, an aryl group having 5 to 25 carbon atoms which contains a hetero atom, an organic group having 6 to 25 carbon atoms which contains a hetero atom and has an aryl group and an alkyl group simultaneously, and a cycloalkyl group having 3 to 8 carbon atoms which contains a hetero atom.

Stated specifically, R⁴, R⁵ and R⁶ may each be any of methyl, ethyl, propyl, vinyl, cyclopropyl, cyclobutyl, cyclopentyl, cyclohexyl, trifluoromethyl, tetrafluoroethyl, ethoxyethyl, oxyethyl, cyanoethyl, carboxymethyl, carboxyethyl, phenyl, phenylmethyl, tolyl, naphthyl, naphthylmethyl, pyridyl, pyridylmethyl, pyrimidyl, pyrimidylmethyl, quinolyl, quinolylmethyl, imidazolyl, imidazolylmethyl, furyl and thienyl groups.

As the cellulose derivative, a cellulose derivative may further be used in which a sulfuric acid group has been introduced to at least part of hydroxyl groups of cellulose.

As the cellulose derivative, a cellulose derivative may still further be used in which a phosphoric acid group has been introduced to at least part of hydroxyl groups of cellulose.

As the cellulose derivative, a derivative represented by the following chemical formula (3) or the following chemical formula (4) may also be used in which hydroxyl group of cellulose have been converted to urethane.

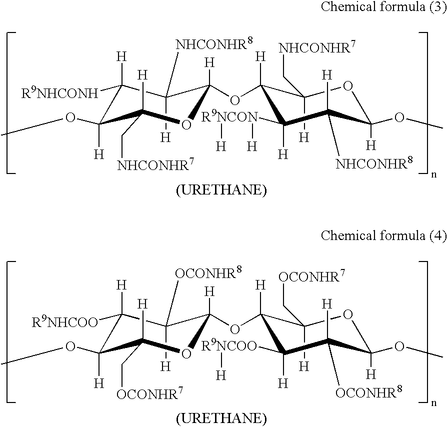

in the chemical formula (3) and (4), R⁷, R⁸ and R⁹ may each be any of a saturated hydrocarbon group having 1 to 18 carbon atoms, an unsaturated hydrocarbon group having 2 to 18 carbon atoms, a cycloalkyl group having 3 to 8 carbon atoms, a fluoroalkyl group having 1 to 18 carbon atoms, a hydroxyalkyl group having 2 to 18 carbon atoms, a cyanoalkyl group having 2 to 18 carbon atoms, a carboxyalkyl group having 1 to 18 carbon atoms, an organic group having 6 to 25 carbon atoms which has an aryl group and an alkyl group simultaneously, an aryl group having 5 to 25 carbon atoms which contains a hetero atom, an organic group having 6 to 25 carbon atoms which contains a hetero atom and has an aryl group and an alkyl group simultaneously, and a cycloalkyl group having 3 to 8 carbon atoms which contains a hetero atom.

Stated specifically, R⁷, R⁸ and R⁹ may each be any of methyl, ethyl, propyl, vinyl, cyclopropyl, cyclobutyl, cyclopentyl, cyclohexyl, trifluoromethyl, tetrafluoroethyl, ethoxyethyl, oxyethyl, cyanoethyl, carboxymethyl, carboxyethyl, phenyl, phenylmethyl, tolyl, naphthyl, naphthylmethyl, pyridyl, pyridylmethyl, pyrimidyl, pyrimidylmethyl, quinolyl, quinolylmethyl, imidazolyl, imidazolylmethyl, furyl and thienyl groups.

(Liquid Crystal Display Apparatus Manufacturing Method:)

A method of manufacturing a liquid crystal display apparatus using the rubbing cloths made of triacetate fibers according to this embodiment (Nos. 1 to 3 in table 1) is described below.

First, a TFT substrate on which driving devices (TFT) have been formed and a CF substrate on which a color filter has been formed were prepared. The polyimide precursor solution (SE-7492, available from Nissan Chemical Industries, Ltd.) was coated on each of them by printing method, followed by heating by means of a hot plate to make solvent evaporation treatment and heat-curing treatment. Thus, a 80 nm thick alignment layer made of polyimide was formed on each substrate. Incidentally, as a varnish used to form the alignment layer, it is by no means limited to the above solution, and a varnish of other type may also be used. For example, a varnish of a polyamic-acid blend type may be used.

Next, the TFT substrate and the CF substrate both having the alignment layers formed thereon were prepared in three sets, and were each subjected to rubbing with the rubbing cloths made of triacetate fibers according to this embodiment (Nos. 1 to 3). The rubbing may be performed under conditions of, e.g., a number of roller revolutions of 1,500 rpm, a pile compression depth of 0.5 mm of the pile end to the alignment layer, and a rate of stage movement of 30 mm/sec.

Next, a sealing compound was coated on edges of the surface of each TFT substrate except for the part serving as a liquid crystal injection opening. On the surface of the other CF substrate, spacer beads for ensuring a stated cell gap for the TFT substrate were dispersed. These TFT substrate and CF substrate were face to face superposed, which were then pressed and heated under stated conditoins to cure the sealing compound and also form the gap. Thus, a liquid crystal cell was formed. The final gap between the TFT substrate and the CF substrate was set to be 5.5 μm.

Thereafter, a liquid crystal composition was injected and filled into the internal space through the injection opening of the liquid crystal cell, and then the injection opening was sealed with an ultraviolet-curing resin. Also, when the resin for sealing was coated, the liquid crystal cell was pressed to make adjustment so that the substrate distance of the resultant liquid crystal display device came in-plane uniform. Here, the distance between the substrates was 5.4 μm. Incidentally, as the liquid crystal composition, any known liquid crystal composition may be used. For example, cyano-type, fluoro-type, cyanofruoro type, biphenyl type, cyclohexane type and phenylcyclohexane type liquid crystals may be used.

The TFT devices on the TFT substrate were electrically connected to a display control circuit unit prepared separately to complete a liquid crystal display apparatus.

For comparison, liquid crystal display apparatus of comparative examples were also manufactured in the same manner as the above except that only the rubbing step was carried out using the rubbing cloth made of rayon according to comparative example (No. 5 in table 1) and the rubbing cloth made of cotton (No. 6 in table 1).

Display performance of the liquid crystal display apparatus thus manufactured was evaluated. The evaluation was made by a method in which any rubbing streaks and rubbing unevenness were examined in halftone display, making it easy to observe the rubbing streaks and rubbing unevenness. As the result, the rubbing streaks and rubbing unevenness were most seen in the liquid crystal display apparatus whose alignment layers were subjected to rubbing with the rubbing cloth made of cotton (No. 6), and the rubbing streaks and rubbing unevenness were least seen in the liquid crystal display apparatus whose alignment layers were subjected to rubbing with the rubbing cloths made of triacetate fibers according to this embodiment (Nos. 1 to 3).

The rubbing cloth made of triacetate fibers according to this embodiment has a great alignment force and a high wear resistance and yet has a low frictional electrification. As having such properties, when the rubbing cloth according to this embodiment is used for the rubbing, not only the liquid crystal molecules can more uniformly be aligned, but also rubbing cloth durability can be improved and any debris (wear dust) can be kept from being produced during the rubbing process. This enables manufacture of a liquid crystal display apparatus having less display unevenness due to any non-uniform alignment of liquid crystal molecules and having less display unevenness due to any gap non-uniformity caused by debris. Also, the use of the rubbing cloth according to this embodiment can prevent streaky unevenness caused during the rubbing process, and may hardly cause any break of TFT devices due to electrostatic electricity.

Thus, the liquid crystal display apparatus manufacturing method making use of the rubbing cloth made of triacetate fibers according to this embodiment is a method by which the uniform alignment of liquid crystal molecules can be attained, any contamination may very less occur on the alignment layer surface and the liquid crystal display apparatus having less rubbing streaks and rubbing unevenness can be manufactured. Thus, highly reliable liquid crystal display apparatus can be manufactured.

As having been described above, the present invention can provide a method of manufacturing a liquid crystal display apparatus, comprising the rubbing step making use of the rubbing cloth having properties of high wear resistance, low frictional electrification and great alignment force together, so as to enable manufacture of a highly reliable liquid crystal display apparatus.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

What is claimed is:

1. A method of manufacturing a liquid crystal display apparatus, comprising a step of rubbing with a rubbing cloth a substrate provided thereon with an alignment layer;
said rubbing cloth comprising a pile portion of raised fibers; said fibers containing a cellulose acetate.

2. The method of manufacturing a liquid crystal display apparatus according to claim 1, wherein said fibers containing a cellulose acetate are filament fibers with crimps.

3. The method of manufacturing a liquid crystal display apparatus according to claim 1, wherein said cellulose acetate has an acetylation degree of 45% or more.

4. The method of manufacturing a liquid crystal display apparatus according to claim 1, wherein said cellulose acetate is cellulose triacetate.

5. The method of manufacturing a liquid crystal display apparatus according to claim 1, wherein said cellulose acetate is cellulose diacetate.

6. The method of manufacturing a liquid crystal display apparatus according to claim 2, wherein said crimps are crimps in a spiral fashion.

7. A method of manufacturing a liquid crystal display apparatus, comprising a step of rubbing with a rubbing cloth a substrate provided thereon with an alignment layer,
said rubbing cloth comprising a pile portion with raised fibers; said fibers comprising a cellulose derivative.

8. The method of manufacturing a liquid crystal display apparatus according to claim 7, wherein said cellulose derivative is a cellulose ester derivative represented by the following chemical formula (1): 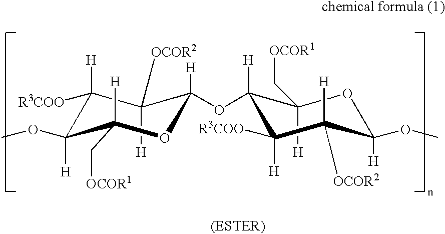
wherein R¹, R² and R³ are each any of a saturated hydrocarbon group having 1 to 18 carbon atoms, an unsaturated hydrocarbon group having 2 to 18 carbon atoms, a cycloalkyl group having 3 to 8 carbon atoms, a fluoroalkyl group having 1 to 18 carbon atoms, a hydroxyalkyl group having 2 to 18 carbon atoms, a cyanoalkyl group having 2 to 18 carbon atoms, a carboxyalkyl group having 1 to 18 carbon atoms, an organic group having 6 to 25 carbon atoms which has an aryl group and an alkyl group simultaneously, an aryl group having 5 to 25 carbon atoms which contains a hetero atom, an organic group having 6 to 25 carbon atoms which contains a hetero atom and has an aryl group and an alkyl group simultaneously, and a cycloalkyl group having 3 to 8 carbon atoms which contains a hetero atom.

9. The method of manufacturing a liquid crystal display apparatus according to claim 7, wherein said cellulose derivative is a cellulose ether derivative represented by the following chemical formula (2): 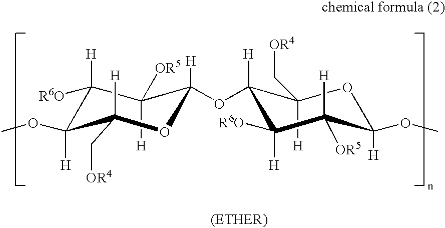
wherein R⁴, R⁵ and R⁶ are each any of a saturated hydrocarbon group having 1 to 18 carbon atoms, an unsaturated hydrocarbon group having 2 to 18 carbon atoms, a cycloalkyl group having 3 to 8 carbon atoms, a fluoroalkyl group having 1 to 18 carbon atoms, a hydroxyalkyl group having 2 to 18 carbon atoms, a cyanoalkyl group having 2 to 18 carbon atoms, a carboxyalkyl group having 1 to 18 carbon atoms, an organic group having 6 to 25 carbon atoms which has an aryl group and an alkyl group simultaneously, an aryl group having 5 to 25 carbon atoms which contains a hetero atom, an organic group having 6 to 25 carbon atoms which contains a hetero atom and has an aryl group and an alkyl group simultaneously, and a cycloalkyl group having 3 to 8 carbon atoms which contains a hetero atom.

10. The method of manufacturing a liquid crystal display apparatus according to claim 7, wherein said cellulose derivative is a urethane derivative represented by the following chemical formula (3): 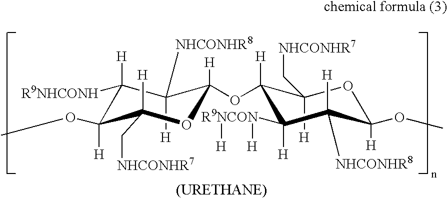
wherein R⁷, R⁸ and R⁹ are each any of a saturated hydrocarbon group having 1 to 18 carbon atoms, an unsaturated hydrocarbon group having 2 to 18 carbon atoms, a cycloalkyl group having 3 to 8 carbon atoms, a fluoroalkyl group having 1 to 18 carbon atoms, a hydroxyalkyl group having 2 to 18 carbon atoms, a cyanoalkyl group having 2 to 18 carbon atoms, a carboxyalkyl group having 1 to 18 carbon atoms, an organic group having 6 to 25 carbon atoms which has an aryl group and an alkyl group simultaneously, an aryl group having 5 to 25 carbon atoms which contains a hetero atom, an organic group having 6 to 25 carbon atoms which contains a hetero atom and has an aryl group and an alkyl group simultaneously, and a cycloalkyl group having 3 to 8 carbon atoms which contains a hetero atom.

11. The method of manufacturing a liquid crystal display apparatus according to claim 7, wherein said cellulose derivative is a urethane derivative represented by the following chemical formula (4): 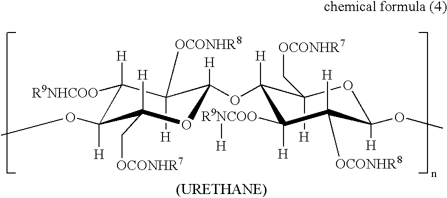
wherein R⁷, R⁸ and R⁹ are each any of a saturated hydrocarbon group having 1 to 18 carbon atoms, an unsaturated hydrocarbon group having 2 to 18 carbon atoms, a cycloalkyl group having 3 to 8 carbon atoms, a fluoroalkyl group having 1 to 18 carbon atoms, a hydroxyalkyl group having 2 to 18 carbon atoms, a cyanoalkyl group having 2 to 18 carbon atoms, a carboxyalkyl group having 1 to 18 carbon atoms, an organic group having 6 to 25 carbon atoms which has an aryl group and an alkyl group simultaneously, an aryl group having 5 to 25 carbon atoms which contains a hetero atom, an organic group having 6 to 25 carbon atoms which contains a hetero atom and has an aryl group and an alkyl group simultaneously, and a cycloalkyl group having 3 to 8 carbon atoms which contains a hetero atom.

12. A method of manufacturing a liquid crystal display apparatus, comprising a step of rubbing with a rubbing cloth a substrate provided thereon with an alignment layer;
said rubbing cloth having a dynamic coefficient of friction with said alignment layer, of 0.53 or more.

13. The method of manufacturing a liquid crystal display apparatus according to claim 12, wherein said rubbing cloth comprises a pile portion of raised fibers; said fibers containing a cellulose acetate.

14. A liquid crystal display apparatus comprising a substrate and an alignment layer provided on said substrate;
said alignment layer having an optical anisotropy of 0.85 degrees or more as a difference between the maximum value and the minimum value in phase difference between an S-wave and a P-wave when said substrate is rotated in main plane.

15. A liquid crystal display apparatus comprising a substrate and an alignment layer provided on said substrate;
said alignment layer having been subjected to rubbing with a rubbing cloth having a pile portion of fibers containing a cellulose acetate.

16. A liquid crystal display apparatus comprising a substrate and an alignment layer provided on said substrate;
said alignment layer having been subjected to rubbing with a rubbing cloth having a pile portion of fibers containing a cellulose derivative.

17. The liquid crystal display apparatus according to claim 15, wherein said alignment layer has an optical anisotropy of 0.85 degrees or more as a difference between the maximum value and the minimum value in phase difference between an S-wave and a P-wave when said substrate is rotated in main plane.

18. The liquid crystal display apparatus according to claim 16, wherein said alignment layer has an optical anisotropy of 0.85 degrees or more as a difference between the maximum value and the minimum value in phase difference between an S-wave and a P-wave when said substrate is rotated in main plane.
